(19) United States
(12) Patent Application Publication
(10) Pub. No.: US 2003/0158719 A1
(43) Pub. Date: Aug. 21, 2003

(54) Self similarity based high speed traffic simulator

(75) Inventors: Shimshon Jacobi, Rehovot (IL); Itamar Elhanany, Santa Clara, CA (US); Michael Kahane, Omer (IL)

Correspondence Address: BROWDY AND NEIMARK, P.L.L.C., 624 Ninth Street, N.W., Washington, DC, 20001, US

(73) Assignee: Teracross Ltd., RamatGan (IL)

(21) Appl. No.: 10/310,995

(22) Filed: Dec. 6, 2002

(30) Foreign Application Priority Data
Feb. 20, 2002 (IL) 148279

(51) Int. Cl. G06F 17/50

(52) U.S. Cl. 703/16

(57) ABSTRACT

A traffic simulator for simulating traffic events in a network, in which the events behave according to one or more statistical models. One or more event sources, are used for randomly issuing one or more events at discrete time slots within a predefined maximum event period. If only one of the sources issues an event at specific time slot, the event is output into an Event Labeler, and if more than one event is being issued at a specific time slot, one of the events is selected and output into the Event Labeler and the rest of the events are postponed to the next time slot. In case more than one event is postponed to a next time slot, one of the postponed event, or possibly a newly issued event, is selected in the next time slot according to a predetermined output selection policy. The selected event is then output to the Event Labeler. An Event Labeler is used to label a destination, being randomly selected from a given list of destinations, to each output event.

### FIELD OF THE INVENTION

The present invention relates to the field of traffic simulation. More particularly, the invention relates to a method and apparatus for simulating traffic of events between a plurality of sources and targets.

### BACKGROUND OF THE INVENTION

Network hardware, including routers and switches of network traffic, are critical components of the internet and of other networks' infrastructure. Therefore, testing of these routers and switches under heavy traffic, including real-life network traffic is crucial for assuring their proper performance and high reliability.

Packet traffic and heavy load transfer, such as in internet core, metropolitan area networks, and real-time voice and video applications, is shown to present Long-Range Dependence (LRD) of data traffic. The Quality of Service (QoS), of such real-time services is a subject of research and development, due to the importance of maintaining reliable and high speed data transfer under high-load data traffics. Such heavy load data transfer scenarios can be tested, in hardware or in software, by way of simulation (traffic simulators), which is typically carried out by generating data streams, originating from one or more sources, based on an acceptable Long-Range Dependence (LRD) model.

Reliable simulation of packet (or cell in the single-size case) arrival in network traffic is a difficult task in network research and development, when trying to analyze the behavior of networks, and particularly routers. In the past, it was acceptable to assume that network traffic packet arrivals would be treated as Poisson processes, mainly due to their theoretical properties. However, it is now understood as a result of many works and studies, that local and wide-area network traffic is better handled as a self-similar processes (Fractal behavior), which maintain different theoretical properties than Poisson processes.

Self-similar traffic behavior is particularly typical in LAN, ATM environment, Wide WAN IP traffic, and WWW traffic (“Self-Similar Network Traffic and Performance Evaluation” K. Park and W. Willinger).

It is difficult to achieve a fast simulation of network traffic in which the statistical properties of self-similar processes are maintained, and which allows changing the fractal behavior, namely, on which different statistical self-similar processes can be simulated. Most of the traffic simulators which are currently used are implemented utilizing computer programs. Those implementations are usually computationally complex and expensive, and therefore relatively slow. For instance, implementations of the fractional autoregressive integrated moving average (F-ARIMA) (W. E. Leland et al, “On The Self-Similar Nature of Ethernet Traffic” (extended version), IEEE/ACM Trans. on Networking, vol. 2, No 1, 1994, pp. 1-15. 20), requires O(n²) computations to generate n numbers. Other algorithms based on Fractional Gaussian Noise (FGN) (V. Paxon “Fast Approximation of Self-Similar Network Traffic”, LBL-36750, Lawrence Berkeley Laboratory, 1995), exhibit faster performance, but are limited to FGN processes only. Hardware simulation of high-bandwidth network links is therefore not simple, and usually requires dedicated hardware setup. Simulating those links in any statistical scenario other than uniform distributions tends to be a technical challenge. Products for injection of simple traffic scenarios into routers in a rate of up to 10 Gbps exist commercially, but they lack the necessary real-world means that are required in order to fully test router forwarding and scheduling algorithms (for example, AdTech AX/4000 product).

A fast and reliable simulation can be obtained utilizing Superposition of Independent Identically Distributed (IID) Fractal Renewal point Processes (hereinafter Sup-FRP), which can be utilized to generate high bit-rate cell streams (10-25 Mbps) (B. K. Ryu et al, “Real-Time Generation of Fractal ATM Traffic: Model, Algorithm, and Implementation”, Technical Report 440-96-06, Center for Telecommunications Research, Columbia University, New York, March, 1996). The Sup-FRP simulator described by Ryu is software implemented utilizing a computer program, and a real-time traffic generation and monitoring system, and it is capable of generating 25 Mbps traffic.

The Sup-FRP model described by Ryu is particularly attractive for network traffic simulation since it allows alterable statistic properties to be tested, e.g., variance of arrival rate, and a fast and accurate generation of fractal time series in a range of several Mbps. FIG. 1A principally illustrates the Sup-FRP point process described by Ryu. The Sup-FRP is composed from a superposition of M independent Fractal Renewal Process (FRP) sources, FRP⁽¹⁾, FRP⁽²⁾, . . . , FRP^{(M)}, each of which generates a cell stream corresponding to a fractal time series t₀^{(j), t}₁^{(j)}, t₂^{(j)}, . . . tᵢ^{(j)} . . . (j=1, 2, . . . M).

Each FRP^{(j)} source corresponds to an independent self-similar process characterized only by a Hurst parameter H (0.5<H<1). The Hurst parameter H is utilized to compute the fractal exponent α=2·H−1 (0<α<1), which defines the process rate of exponentially decaying variance and range dependency. The interarrival probability density function p(t) of cells is defined by (1):

$$p ( τ ) = \{ \begin{matrix} γ \cdot {A}^{- 1} \cdot {ⅇ}^{- γ \cdot t / A} for t \leq A \\ γ \cdot {ⅇ}^{- γ} \cdot A \cdot γ \cdot {t}^{- ( γ + 1 )} for t > A\end{matrix} \qquad ( 1 )$$

wherein γ=2−α, and A is a threshold according to which an exponential or power-law behavior of the time intervals t is chosen.

The equilibrium distribution of the inter-arrival probability density function p(t) is utilized to compute random time intervals for each FRP^{(j)} source, utilizing an uniformly distributed IID random process. While this method allows a fast and accurate generation of fractal time series, it only provides simulation of self-similar cell arrival from a single channel, but do not apply such properties for the cells destinations in either its destination distribution or burstiness, which are required in order to check the forwarding and scheduling mechanisms of a router device.

The abovementioned principles are utilized by Ryu to realize a fast Sup-FRP (Fractal Renewal Process) simulator. However, due to its software implementation as well as computational complexity, it is still not capable of simulating inter-arrival of fast communication links e.g., in a rate of 10 Gbps and beyond, in which tens of millions of cells are passing each second. Moreover, the Sup-FRP does not provide multiple stream traffic generation, and thus can not be utilized for simulating specific destination distributions, in which for example spatial distribution of the traffic is created.

In the Sup-FRP implementation described by Ryu the time intervals computation is carried out on a real, continuous time axis This is convenient, especially since it substantially minimizes the risks of conflicting arrivals, that is, obtaining more than one cell arrival from an FRP source at a given time. In other words, in continuous (real) time packet simulation the risk of arrival conflicts (i.e., simultaneous packet arrivals from different sources) is negligible.

However, this is not the case in simulation of discrete time packet arrivals, especially when going to high loads (90-100%). In such cases, conflicting scenarios are frequent. FIG. 1B schematically illustrates a discrete Sup-FRP, wherein cell arrival time is limited to k·T wherein k is a positive integer and T, is a fundamental time slot on a discrete time axis. As demonstrated in FIG. 1B, cell conflict incident may occur when two cells are scheduled by different sources, on a same time slot in the discrete time axis. For example, in FIG. 1B, two cells are scheduled by the FRP⁽¹⁾ and FRP⁽²⁾ sources in a same time slot, T+9Ts. In applications in which cell streams (also termed herein as “bursts”) often occur (e.g., MPEG) such conflicts are more probable, and may result in rejection of one or more cells sources. One way of dealing with such conflicts requires storage means (memory) for storing the excess of arriving cells.

It is important to note that such treatment, wherein an excess of arriving cells are queued utilizing a memory device, is not favorable when simulating cell arrival wherein the statistical properties of the cell sources should be maintained. Such a queue introduces delays in the receipt of the arrived cells, and thus deteriorates the statistical properties of the queued arrival process for the relevant source. It also substantially complicates the implementation of the generation mechanism, as it requires memory and memory management for cells buffering.

It is an object of the present invention to provide a fast and accurate traffic simulator implemented by a simple, compact and reliable hardware.

It is another object of the present invention to provide a fast and accurate traffic simulator for simulation of network traffic in a discrete time domain wherein incidents of conflicting cells arrival are excluded, without deteriorating the statistical properties of the cell sources.

It is a further object of the present invention to provide a fast and accurate traffic simulator wherein the source and destination of the generated events have self-similar properties.

It is still another object of the present invention to provide a fast and accurate discrete time traffic simulator for simulation of network traffic allowing simulation of high-load data traffic wherein close to 100% of the time slots are occupied.

It is yet another object of the present invention to provide a fast and accurate discrete time network traffic simulator allowing simulation of a multiple-source, multiple-destination, and multiple-flow traffic scenarios in which each of the source-to-destination flow rates can be reloaded in a simple manner and during device continuous operation.

It is still a further object of the present invention to provide a fast and accurate discrete time network traffic simulator allowing simulation of a multiple-source, multiple-destination, and multiple-flow traffic scenarios in which some or all of the source-to-destination flows behave in a self-similar manner.

It is yet a further object of the present invention to provide a fast and accurate discrete time network traffic simulator allowing simulation of a multiple-source, multiple-destination, and multiple-flow traffic scenarios in which the destination distribution for each source can be chosen to be uniform, or non-uniform with any desired probability distribution among destinations, and can be reloaded in a simple manner and during device continuous operation.

An additional object of the present invention is to provide a fast and accurate traffic simulator in which a predefined policy is utilized to control data traffic bursts according to the source rate and statistical properties.

Other objects and advantages of the invention will become apparent as the description proceeds.

### SUMMARY OF THE INVENTION

The present invention is directed to a traffic simulator and a method for simulating traffic events in a network, in which the events behave according to one or more statistical models. The traffic simulation comprises randomly issuing, by one or more event sources, at least one event within a predetermined maximum event period, and If only one event being issued at any specific instance, outputting the same into an Event Labeler. Otherwise, if more than one event being issued at a same specific instance, selecting one of the events, outputting the same into the Event Labeler, and postponing the rest of the events to the next time instance. If more than one event was postponed to a next instance, selecting in the next instance, according to a predetermined outputting selection policy, one event and outputting the same to the Event Labeler from the postponed events and possibly from newly issued events. The Event Labeler labels a destination to each outputted event or a number of following events, the destination being randomly selected from a given list of destinations.

According to a preferred embodiment of the invention the traffic simulation further comprises labeling of a number of consecutive output events in the labeling step, the labels of the sequentially labeled events being determined according to a predetermined destination assignment policy. Alternatively, the predetermined destination assignment policy can generate non-uniform destination distributions in the labeling step.

The traffic simulation may further comprise generating labels of constant-label bursts and of variable length in the labeling step, while maintaining the same integral traffic statistics. The time instances are preferably discrete.

### BRIEF DESCRIPTION OF THE DRAWINGS

In the drawings:

FIGS. 1A and 1B schematically illustrate the Sup-FRP implementation in non-discrete and discrete time domains, respectively;

FIG. 2 is a block diagram illustrating a possible test array of traffic events;

FIG. 3 schematically illustrates a Traffic Synthesis Unit according to a preferred embodiment of the invention;

FIG. 4 schematically illustrates the structure of an Event Generator according to a preferred embodiment of the invention;

FIGS. 5A and 5B schematically illustrate preferred embodiments for a Next-Event Scheduling Unit;

FIG. 6 schematically illustrates a preferred embodiment of the interarrival time generator;

FIG. 7 schematically illustrates a preferred embodiment of the Event Labeler;

FIG. 8 schematically illustrates a preferred embodiment of the Burst Controller;

FIG. 9 is a look-up table exemplifying a possible policy for generation of new labels; and

FIG. 10 schematically illustrates a preferred embodiment of the Label Generator.

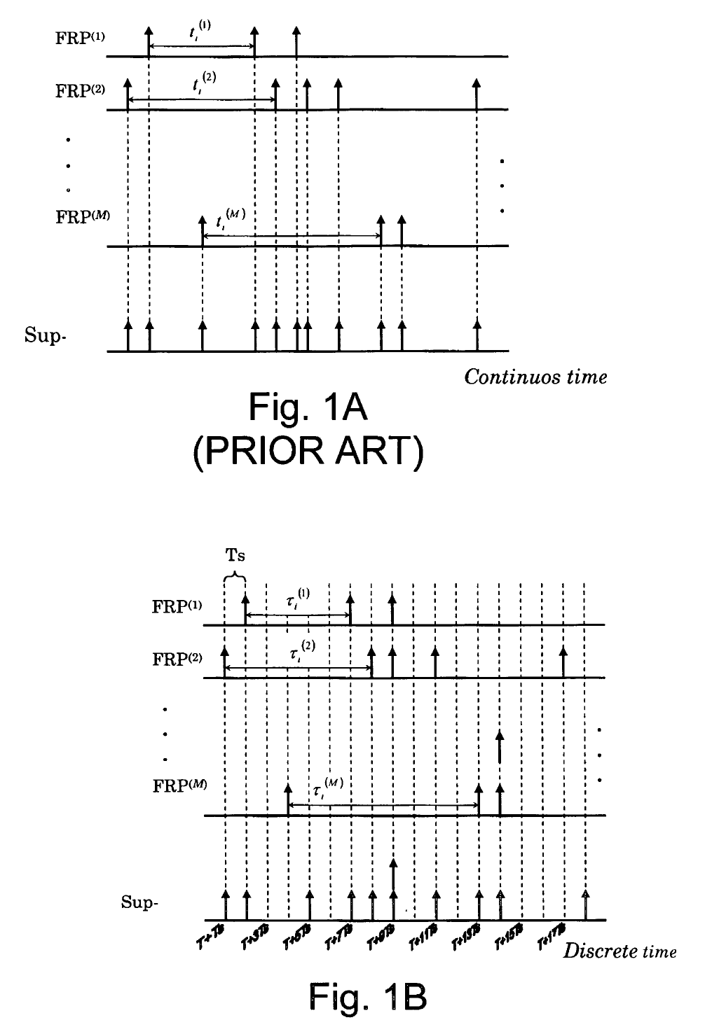

### DETAILED DESCRIPTION OF PREFERRED EMBODIMENTS

Throughout this application a reference is made to several terms, as follows:

Router: A device or a computer program that determines the next network node to which a packet should be forwarded, and then schedules and performs the forwarding.

Self-Similar process: A Statistical process having the same statistical properties on all scales, or on a wide range of scales.

Fractal Renewal Process: A self-similar statistical process, that a plurality of which can be combined so as to provide a self-similar process with different statistical parameters.

Hurst parameter: A parameter of the fractal renewal process, which sets its degree of self-similarity.

The present invention is directed to a hardware implementation of a discrete time traffic simulator in which traffic events are randomly generated by a plurality of different sources, and randomly assigned with a destination. In a preferred embodiment of the invention, fractal processes are utilized by some (or all) of the sources, to schedule traffic events, and each traffic event is assigned a target destination, which may be also achieved by using a fractal process (or any other random process), and wherein the distribution function of destinations may be set. Such an implementation is particularly useful for network simulations exhibiting data traffic streams (bursts), which often lead to full occupation of the available transmission band, and which include plurality of network traffic source and destination nodes. As such, the simulator of the invention is to be implemented for benchmarking and testing of median and high-throughput router devices and switch fabric devices.

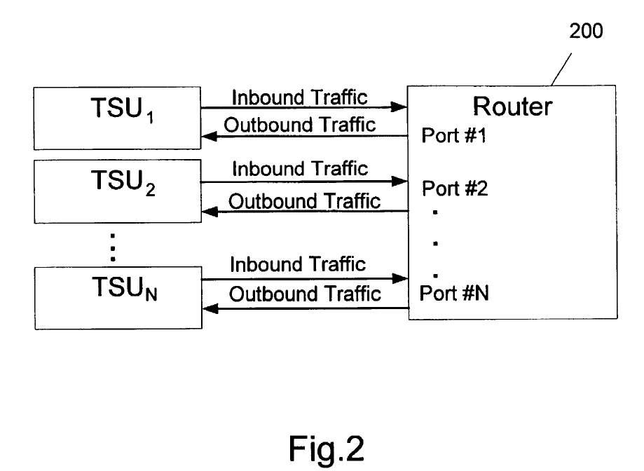

FIG. 2 is a block diagram illustrating a preferable test setup for simulation of packet arrival from a plurality of data sources. In this simulation setup, the tested router 200 is linked to N Traffic Synthesis Units (TSU), TSU₁, TSU₂, . . . ,TSU_{N}, via router ports, Port#1, Port#2, . . . , Port#N. Each TSU may be programmed to generate a different type of packet traffic, having different statistical properties. In a preferred embodiment of the invention, some, or all the TSUs generate packet traffic having self-similar behavior, which is known to best characterize the network traffic.

Each router port (Port#i; i=1, 2, . . . ,N) is provided with packet traffic originated from the corresponding TSU₁, on Inbound Traffic (IT) line. The router, when performs in its normal operation, forwards the traffic provided on the IT line towards the respective Outbound Traffic (OT) on the port output, as indicated by the destination labeling (j, not shown) on the cells. The router performance can be monitored by checking the router status, or by analyzing the OT lines.

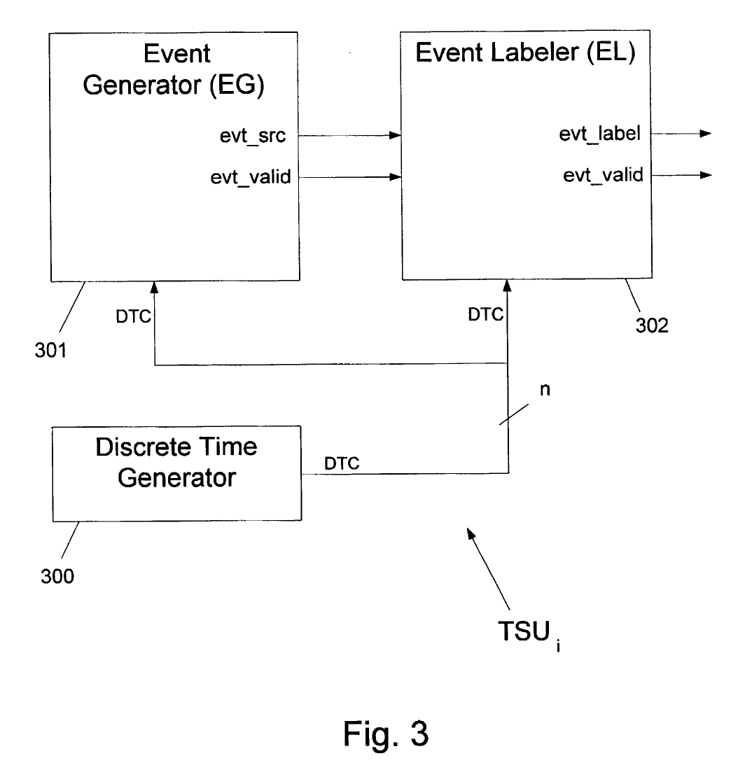

FIG. 3 illustrates in a block diagram form a TSU according to one embodiment of the invention. Each TSU consists of an Event Generator (EG) 301 and an Event Labeler (EL) 302. The EG 301 and the EL 302 receive a simulation time signal on the Discrete Time Clock (DTC) line which is the output of the Discrete Time Generator (DTG) 300. It should be noted that the signal provided on the DTC line is not a clock pulse, but instead it should comprise the simulator's discrete time (0 to 2ⁿ−1). The rate of the DTG 300 determines the TSU fundamental time slot Ts. The EG 301 produces two outputs, the evt_src (event source), and the evt_valid (event valid), which are input to the EL 302.

The term “event” is utilized herein to indicate packet arrival event. Thus, whenever the evt_valid output of the EG 301 is TRUE, this indicates to the EL 302 a packet arrival, and the signal on the evt_src line indicates the packet origins, as will be explained in more detail hereinafter.

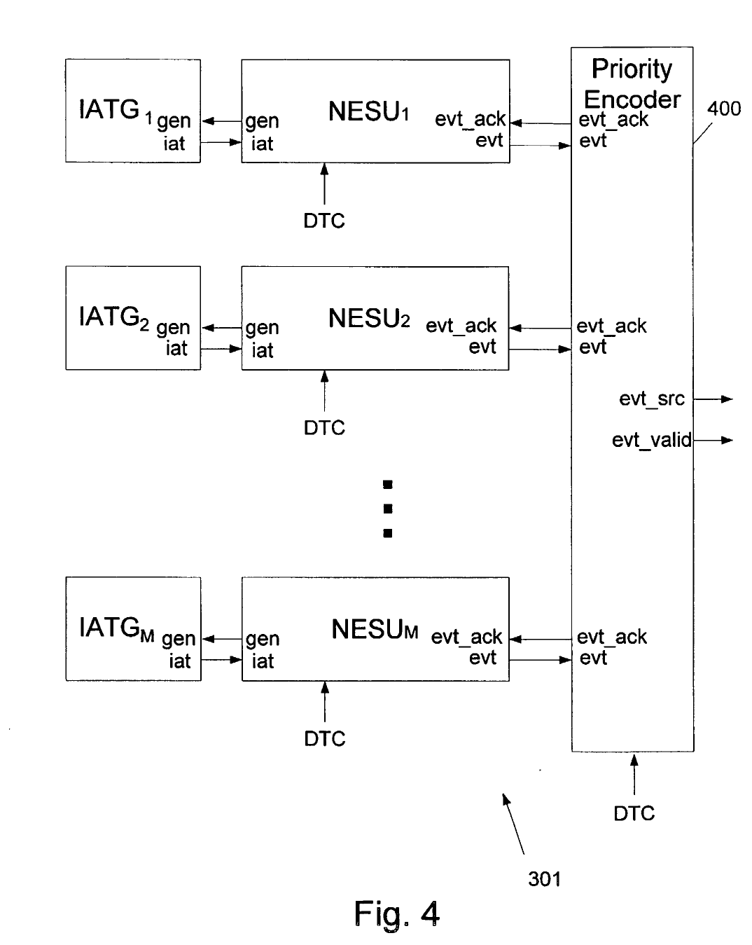

The EL 302 utilizes the evt_src and evt_valid inputs to generate a label (packet destination) whenever a TRUE event indication is received on the evt_valid input (evt_valid=TRUE). Two outputs are provided from the EL 302, the evt_label (event label), and evt_valid, which corresponds to the signal received on the evt_valid input, but which may be delayed in order to comply with the time of the corresponding evt_label output. The evt_label produced by the EL 302 may be directly based on the signal obtained on the evt_src input, and thus exhibiting the same statistical parameters in the label domain as in the event source domain. Alternatively, the labels (evt_label) produced for each valid event may be generated utilizing other methods, to create complex behaviors on the label domain, which emerge from the processing of the source statistics, as will be described herein later. The structure of the EG 301, according to an embodiment of the invention, is schematically illustrated in FIG. 4. The EG 301 comprises M Next-Event Scheduling Units (NESU), NESU₁, NESU₂, . . . , NESU_{M}, each of which acts as a possible source of arriving packets (events). Each NESUᵢ (i=1, 2, . . . ,M) has an evt (event) output which is attached to the Priority Encoder (PE) 400. If one or more events are introduced at the PE 400 evt inputs, the PE determines which of the evt sources (the corresponding NESUᵢ) inputs is chosen as the current source event, which is then indicated on the PE 400 evt_src output. Once the PE selects an active source, an acknowledgment signal is provided on the respective evt_ack output, which is received by the respective NESUᵢ. In addition, a valid indication is provided on the PE 400 evt_valid output.

Each NESUᵢ receives an iat (inter-arrival time) input from a respective Inter-Arrival Time Generator (IATG), IATG₁, IATG₂, . . . , IATG_{M}, and each NESUᵢ provides the respective IATGᵢ with a “generate” request on the gen input, whenever generation of a new IAT is required. The IATGs provides the time intervals τᵢ^{(j)} (j=1, 2, . . . , M) which exhibits the desired distribution. Each IATGᵢ may be uniquely programmed to generate time intervals τᵢ(j) corresponding to different statistic properties. In a preferred embodiment of the invention an FRP distribution is utilized for the time intervals τᵢ(j) generation. Each pair of IATG and NESU units actually define a source of events, and therefore they will be also referred to as source events hereinafter.

It is possible to implement the EG 301 by utilizing a single IATG, which provides the time intervals τᵢ(j) for each and every NESUᵢ. Such an implementation is particularly attractive thanks to the operation of the PE 400, which ensures that in each specific time a maximum of one NESU is selected as the active source, and thereby generation of conflicting events is avoided.

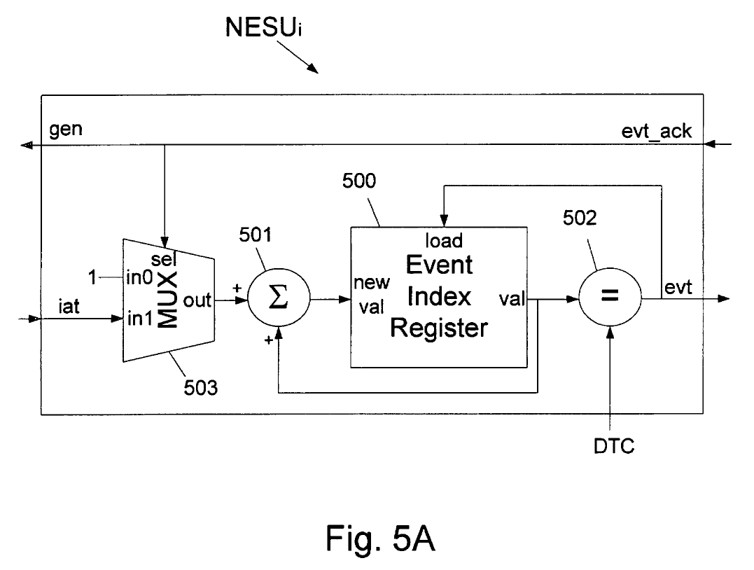

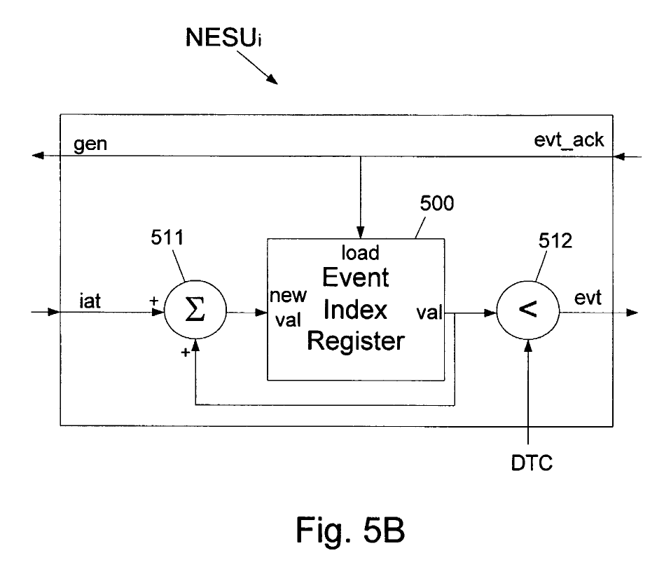

Two possible embodiments of the NESU are shown in FIGS. 5A and 5B. In both cases, the principle of operation is similar. An evt (event) indication is output whenever the DTG 300 time provided on the DTC line is equal to (FIG. 5A), or is greater than (FIG. 5B), the time of the next event scheduled, which is stored in the Event Index Register (EIR) 500.

In the NESU of FIG. 5A, the evt signal is produced whenever equality between the DTC time and the EIR 500 content is determined by comparator 502. Appearance of the evt signal drives the load input of the EIR 500, which in effect loads the time of the next event according to the value on its new_val input, which equals the summation result of the adder 501. The adder 501 carries out summation between the present value stored in the EIR 500, and the value of the multiplexer (MUX) 503 out output.

The inputs to the MUX 503 are in1, which receives the IAT generated by the respective IATG, and in0, which is fed constantly by a “1” value. The signal on the evt_ack input acts as a control, according to which the appropriate input is selected (in0 or in1). If the PE 400 selects the NESU as the active event source, i.e., an acknowledgment signal is provided on the evt_ack input, the value on the in1 input is selected. Namely, the new time scheduled is set to the current scheduled time stored in the EIR 500 plus the new time interval introduced by the iat input. Otherwise, if comparator 502 indicates equalization and the evt output is not acknowledged, i.e., evt_ack=FALSE, the value on the in0 input (i.e., “1) is selected. Namely, the content of the EIR 500 is incremented by 1, until the PE 400 (FIG. 4) acknowledges the receipt of the event evt from the NESU. It should be noted that in such an embodiment, the IATG should be designed such that zero time intervals are not allowed i.e., τᵢ(j)>0 ∀i,j.

A different approach is utilized in the NESU of FIG. 5B. In this embodiment, the evt signal is produced whenever the comparator 512 indicates that the DTC time received from the DTG 300 is greater than the time stored in the EIR 500. Additionally, the summation performed by adder 511 always produces the sum of the current value stored in the EIR 500 and the IAT provided on the iat input. Thus, whenever event acknowledgment is provided by the PE 400 (FIG. 4), on the evt_ack input of the NESU, the EIR 500 content is loaded via its new_val input with the summation result of adder 511, that is the sum of current scheduled time and the IAT time interval r,

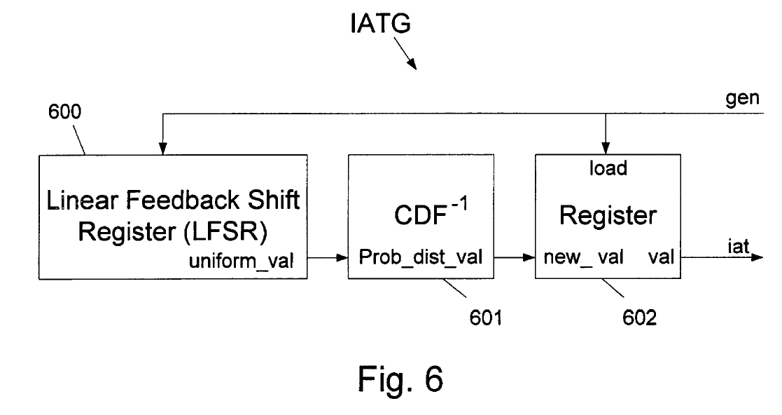

The IATG is preferably implemented utilizing a look-up table which is loaded into the CDF⁻¹ 601 as illustrated in FIG. 6. The CDF⁻¹ block 601 provides a random number with any requested probability density function, given a random number with a uniform probability density function. More specifically, the CDF⁻¹ (Inverse Cumulative Probability Density Function) includes a look-up table. Each address in this table is assigned a probability that an Inter-Arrival time is equal to a certain value, which resides in this address. The Inter-Arrival time value is then retrieved from the corresponding address by the look-up process. Whenever a request for generation of a new IAT is provided on the gen input, a pseudo-random integer is preferably produced by a Linear Feedback Shift Register (LFSR) 600, and forwarded to the CDF⁻¹ 601 on the uniform_val output. The CDF⁻¹ 601 utilizes the value on the uniform_val input as a look-up index to fetch an IAT from the preloaded look-up table. The looked-up Inter Arrival Time (IAT) is actually the time interval τᵢ(j) which is utilized by the EG 301 to determine the time of the next event. The IAT value is loaded into register 602 via the probability distribution value prob_dist_val output of the CDF⁻¹ 601. This value is then introduced through the register val output on the iat line, until the new event is acknowledged. It is therefore apparent (as illustrated in FIGS. 5A and 5B) that the acknowledge signal provided by the PE 400 on the evt_ack output is also utilized as a request for IAT generation on the gen input.

Each look-up table may be loaded with values corresponding to different statistical distributions. For instance, one may utilize equation (1) to simulate IATs having self similar. This is typically carried out by transferring the random process into a discrete process, and thereby defining a minimal and maximal event periods. The LFSR 600 should be loaded with a new seed for each simulation, in order to obtain a random set of IATs. Preferably, each LFSR 600 (when more than one IATG is utilized) is loaded with a different seed, or alternatively, each IATG is configured differently such that different sequences of pseudo-random integers are obtained from each LSFR even if they are loaded with the same seed.

As was mentioned hereinbefore, the operation of the PE 400 prevents conflicting events from affecting the IAT processes, by allowing only one NESU to be active in each cycle. The PE 400 may be implemented in various ways: one may adopt a straightforward approach in which the NESUᵢ having the smaller/greater index is of the highest priority to be selected. Alternatively, the PE 400 may be implemented with capabilities of memorizing sequences of past events, such that lower priority is given to the NESUs that were active recently.

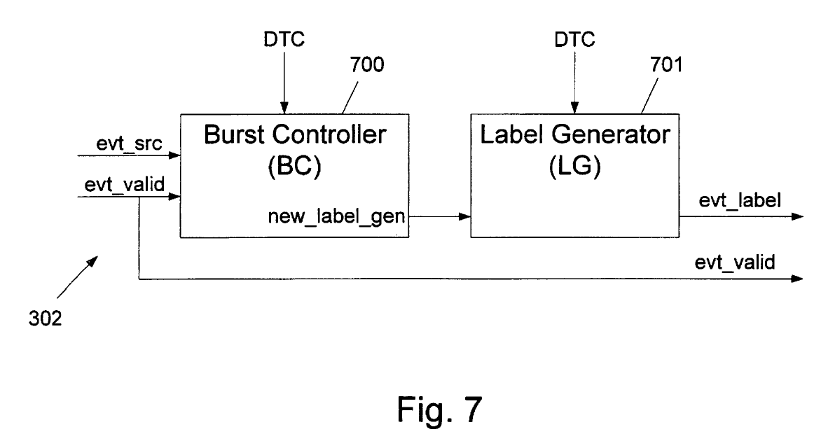

A block diagram of the EL 302 is illustrated in FIG. 7. As shown in FIG. 3, the EL 302 receives two inputs, evt_src and evt_valid, from the EG 301, and provides two outputs, evt_label and evt_valid. The inputs of the EL are provided to the Burst Controller (BC) 700 (FIG. 7), which is utilized to determine when a new label should be produced. Whenever a new label is required, the request for a new label triggers the Label Generator (LG) 701, via the BC 700 output new_label_gen. The label produced by the LG 701 is then provided on the LG evt_label output line. The BC 700 and the LG 701 are preferably synchronous units and hence the DTC signal is provided to each as input.

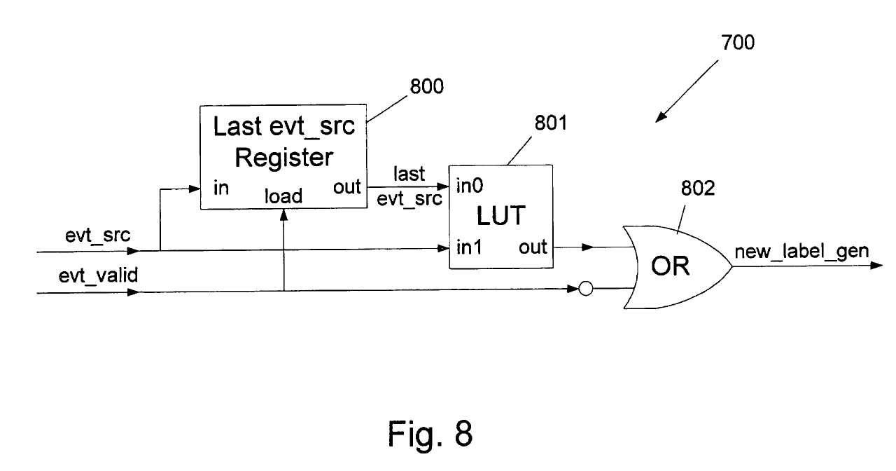

The BC 700 is utilized to determine whether a possible destination is being provided with a data stream (burst). It uses for that purpose the current source evt_src (Sᵢ) the previous event source (Sᵢ₋₁) last_evt_src, and a predetermined burst policy (LUT), to produce an event continuity determination, as illustrated in FIG. 8. The source of the last event is stored in the Last evt_src Register 800, which is triggered by the evt_valid input to store the value provided on the evt_src input. The source of the last event is provided on register 800 output, via the last_evt_src line. A Look-Up Table (LUT) 801 is utilized to determine whether the generation of a new label is required. The LUT 801 is loaded with a predetermined policy for setting the target label. It receives the values on the evt_src (Si) and last_evt_src (Sᵢ₋₁) lines as inputs, and outputs a request for the generation of a new label on its out output. A logical OR gate 802 is used for outputting a request for generation of a new label, on the new_label_gen line, whenever such a request is provided on the LUT 801 out output, or (optionally) when the signal on the evt_valid input is in the FALSE state. It should be noted that OR gate 802 is optional, for instance, in a simpler implementation of the BC 700 one may take the LUT 801 output out as the new_label_gen signal.

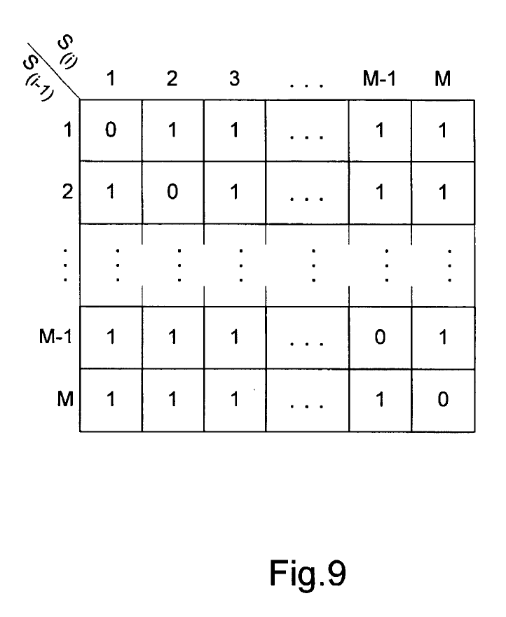

The LUT is constructed according to a predetermined burst policy (also referred to as destination assignment policy). For example, such a policy may be one in which a request for the generation of a new label is issued whenever it is determined that the event source had changed (Sᵢ≠Sᵢ₋₁), as exemplified in the LUT of FIG. 9. In another possible policy a request for a new label generation is issued only upon transition between certain source pairs (Sₐ, S_{b} which are predefined sources), for a longer mean burst length.

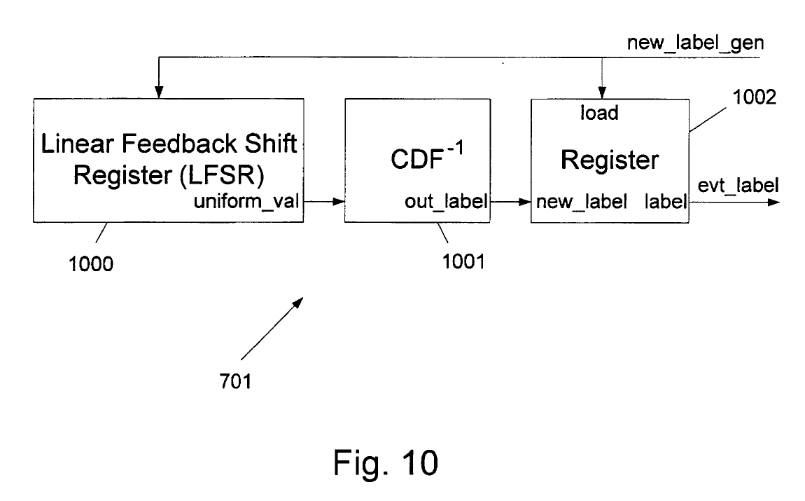

The LG 701, according to an embodiment of the invention is schematically illustrated in FIG. 10. It is similar in structure to the IATG, and likewise similarly utilizes a CDF⁻¹ 1001 unit to which a look-up table is loaded. Whenever a request for generation of a new label is issued on the new_label_gen line, a new pseudo-random integer is produced by the LSFR 1000, and provided on its output uniform_val. This value drives the CDF⁻¹ input upon which a new label is generated for the current event, which is provided on the CDF⁻¹ 1001 output out_lable. The new label is stored in register 1002, from which it is provided on the LG 701 evt_lable output line.

It will be appreciated by those having skill in the art that hardware realization of the traffic simulator of the invention, as described and illustrated hereinabove, provides a significantly faster and more accurate traffic generation than the prior art methods, which are mainly complex software applications. As was discussed and shown, the traffic simulator of the invention provides a discrete time domain simulation in which simultaneous arrival of conflicting cells does not occur, while maintaining the statistical properties of the cell sources.

The traffic simulator of the invention uses look-up table schemes to implement the random processes and the burst policy. It should be noted that the same LUT may be utilized for both the NESU and the LG 701, and as a results the source scheduling and the destination labeling will be of the same statistical properties. It is therefore preferable to implement the NESU and the LG 701 utilizing different LUTs devices, wherein each LUT is loaded according to the appropriate statistical process to be simulated. The LUT devices may be implemented utilizing rewritable memories (e.g. RAM), thus allowing more flexibility in the selection of the statistical properties for simulation.

It should be understood that the traffic simulator of the invention can be used to simulate high-load data traffic wherein close to 100% of the time slots are occupied, without introducing delays in packet traffic, and without spoiling the statistical properties of the EGs. These aspects are not dealt with in prior art solutions, and particularly unique to the invention which additionally allows such simulations to perform in very high rates.

While some embodiments of the invention have been described by way of illustration, it will be apparent that the invention can be carried into practice with many modifications, variations and adaptations, and with the use of numerous equivalents or alternative solutions that are within the scope of persons skilled in the art, without departing from the spirit of the invention or exceeding the scope of the claims.

1. A method for simulating traffic events in a network, in which said events behave according to one or more statistical models, comprising:
a) Providing one or more event sources, each of which being capable of randomly issuing one or more events at discrete time slots within a predefined maximum event period;
b) Issuing traffic events by said sources;
c) If only one of said sources issues an event at specific time slot, outputting the event into an Event Labeler.;
d) If more than one event being issued at a specific time slot, selecting one from said events, outputting the same into said Event Labeler, and postponing the rest of the said events to the next time slot;
e) If more than one event is postponed to a next time slot in step (d), selecting in said next time slot one postponed event or possibly a newly issued event, according to a predetermined output selection policy, and outputting the selected event to the Event Labeler; and
f) Labeling by said Event Labeler a destination to each output event, said destination being randomly selected from a given list of destinations.

2. A method according to claim 1, further comprising the labeling in the labeling step of a number of consecutive output events, the labels of said consecutive labeled events being determined according to a predetermined destination assignment policy.

3. A method according to claim 1, wherein the labeling step comprises a predetermined destination assignment policy that can generate non-uniform destination distributions.

4. A method according to claim 1 for simulating bursts comprising in the labeling step, the assignment of a same destination to a group of consecutive outputted events.

5. A method according to claim 1, wherein the time slot are discrete.

6. An event generator for generating traffic events, comprising:
a) One or more event sources each of which being capable of generating a traffic event, comprising:
a.1) An inter-arrival time generator capable of generating a random value whenever a generate signal is provided to it;
a.2) A discrete time generator for generating sequential readable discrete time count;
a.3) A scheduling unit for receiving said random value and a time count, storing a sum of said random value and time count whenever said generate signal is issued, and outputting an event indication whenever the time count is greater than or equal said stored sum;
b) An arbitration unit for receiving in its input event indications from the scheduling units, selecting one of said event indications, and issuing an event output signal indicating the originating source of said event, and an event acknowledge signal that is provided to the respective originating source;
wherein said event acknowledge signal performs as a new generate signal for the inter-arrival time generator.

7. An event generator according to claim 6, further comprising an event labeler for receiving the event output signals and generating a label for each of said event output signals, said event labeler comprising:
a)A burst controller for receiving said event output signals and producing a generate label signal, according to the source of said event and/or some predefined policy, whenever a new label should be produced;
b)A label generator for randomly producing and outputting a new destination from a predefined set of possible destinations, whenever said generate label signal is produced by said burst controller.

8. An event generator according to claim 6, wherein the random values generated by the inter-arrival time generator form a self-similar process.

9. An event generator according to claim 6, wherein the random values generated by the inter-arrival time generator form a Poisson process.

10. An event generator according to claim 6, wherein the average traffic load generated approach 100%.

11. A scheduling unit according to claim 6, comprising:
a) A storage unit for storing a scheduled discrete time whenever an event acknowledge signal is issued;
b) An adder for summing the content of said storage unit, being provided by its first input, and the random value received from the interarrival time generator, provided by its second input; and
c) a comparator for producing the event indication whenever the discrete time count is greater than the scheduled discrete time stored in said storage unit;
wherein the adder summation result is used as the scheduled discrete time stored in said storage unit.

12. A scheduling unit according to claim 11, wherein an event indication is issued by the comparator whenever the discrete time count equals to the scheduled discrete time that is stored in the storage unit.

13. A scheduling unit according to claim 12, further comprising an arbitration device for selecting the input to the second input of the adder, where said value is chosen to be:
a new random value from the inter-arrival time generator, whenever an event acknowledge signal is issued, or
a “1” value otherwise.

14. An inter-arrival time generator according to claim 6, comprising:
a) circuitry for producing random values;
b) a storage device for storing a look-up table corresponding to a predefined random process, and for outputting a stored value via a look-up process according to values produced by said circuitry; and
c) a temporary storage device for storing said stored values received provided from said storage device.

15. An inter-arrival time generator according to claim 14, wherein the circuitry utilized for producing random values is a Linear Feedback Shift Register.

16. A burst controller according to claim 7, comprising:
a) a first storage device for storing the source of the previous event output signal; and
b) a second storage device for storing a look-up table being used for outputting the generate label signal via a look-up process by which said signal is looked-up using the value stored in said first storage device and the source of the current event output signal.

17. A burst controller according to claim 16, further comprising a logical OR gate for producing a generate label signal whenever an event output signal is issued.

18. A label generator according to claim 7, comprising:
a) circuitry for producing random values;
b) a storage device for storing a look-up table being used for outputting stored destination values via a look-up process by using the values produced by said circuitry; and
c) a temporary storage device for storing and outputting said stored destination values outputs, received from said storage device.

19. A label generator according to claim 18, wherein the circuitry utilized for producing random values is a Linear Feedback Shift Register.

20. A simulation array comprising a plurality of event generators as in claim 6, each of which is linked to a router port, wherein said router is capable of receiving traffic events via its ports and forwarding said events to their destinations.
